(19) United States
(12) Patent Application Publication
(10) Pub. No.: US 2005/0239947 A1
(43) Pub. Date: Oct. 27, 2005

(54) Polymeric silver layer

(76) Inventor: David Andrew Greenhill, South Gloucester (GB)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/063,206

(22) Filed: Feb. 22, 2005

Related U.S. Application Data
(60) Provisional application No. 60/548,431, filed on Feb. 27, 2004.

(51) Int. Cl. C08L 1/00

(52) U.S. Cl. 524/495

(57) ABSTRACT

The present invention provides a conductive polymeric composition comprising: (a) functionalized silver particles; (b) organic polymer resin; dispersed in (c) solvent wherein the silver particles are functionalized by least partially coated with a surfactant and heated at a temperature in the range of 100-400° C.

### BACKGROUND OF THE INVENTION

Electrolytic capacitors (e.g. tantalum capacitors) are increasingly being used in the design of circuits due to their volumetric efficiency, reliability, and process compatibility. For example, one type of capacitor that has been developed is a solid electrolytic capacitor that includes an anode (e.g., tantalum wire surrounded by sintered tantalum powder), a dielectric oxide film (e.g., tantalum pentoxide, Ta₂O₅) formed on the anode, a solid electrolyte layer (e.g., manganese dioxide, MnO₂), and a cathode. Various other layers can also be applied to the solid electrolyte layer, such as graphite and silver dispersion layers successively applied to the manganese oxide layer prior to attaching the anode and cathode lead terminals onto the capacitor.

Numerous modifications to each of the portions or layers of the tantalum capacitor have been noted in the prior art to overcome shortcomings such as 1) large equivalent series resistance (ESR); 2) leakage current; and 3) stability issues.

For example, some electrolytic capacitors have replaced the MnO₂ layer with other materials such as a conductive polymer layer (e.g., polypyrrole, polythiophene, polyaniline, polyacetylene, poly-p-phenylene). Examples of such capacitors are described in U.S. Pat. Nos. 5,457,862; 5,473,503; and 5,729,428 each to Sakata, et al.

The present inventor desired to create a composition which demonstrated improved efficiency and lower resistive losses in electronic applications. In particular, the present inventor desired to create a composition and method for use in the formation of capacitors, which demonstrates a lower ESR, lower leakage current, and longer-term stability.

### BRIEF DESCRIPTION OF THE DRAWINGS

FIG. 1 provides a configuration representative of a Ta capacitor in cross section where the polymeric silver layer of the present invention is represented by 101. Layer 103 represents a carbon layer, 104 represents a manganese dioxide layer, 105 represents a tantalum pentoxide layer, 106 represents a tantalum powder (sintered), 107 represents the tantalum wire, and 108 represents the insulating collar.

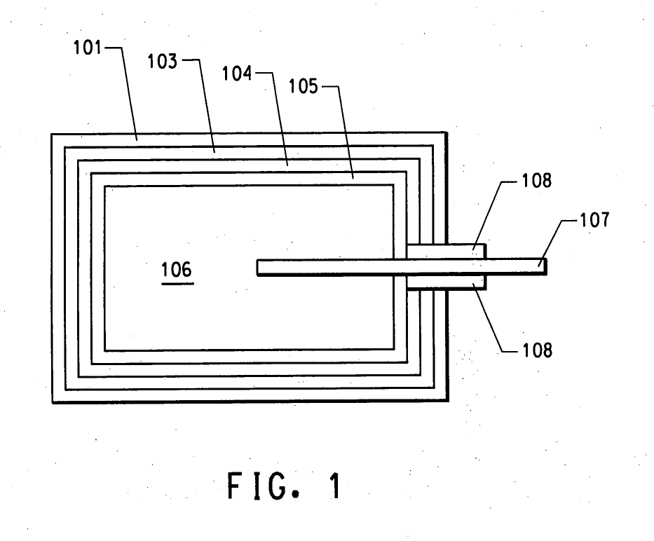

### SUMMARY OF THE INVENTION

The present invention provides a conductive polymeric composition comprising: (a) functionalized silver particles and (b) organic polymer resin dispersed in (c) solvent.

Further provided by the present invention is a method of forming a polymeric silver layer for use in a tantalum capacitor comprising; the steps of the method comprising: (a) providing functionalized silver particles; (c) providing an organic polymer resin; and (d) dispersing the functionalized silver particles of (b) and the organic polymer resin of (c) in a solvent. Additionally, the present invention provides a tantalum capacitor comprising; (a) an anode; (b) a dielectric film overlying said anode; (c) a solid electrolyte layer; (d) a conductive carbon or graphite layer; and (e) a polymeric silver layer; wherein the polymeric silver layer is formed from functionalized silver particles.

The present invention also provides a method to functionalize silver particles by at least partially coating silver particles with surfactant and heat-treating the particles at a temperature in the range of 100-400° C.

### DETAILED DESCRIPTION OF THE INVENTION

The composition of the present invention may be useful in various electronic applications, including conductors and resistors. However it is particularly useful as a polymeric silver layer in tantalum, niobium, and niobium oxide capacitors. The main components of the silver composition will be discussed herein below:

Functional Silver

The term “functionalized” as used herein means a method of modifying a conductive particle by first at least partially coating the particles with a surfactant and then heat-treating the particles at a temperature in the range of 100-400° C.

Silver particles which may be functionalized according to the present invention may be in the form of silver flakes, deagglomerated silver, irregular silver, spherical silver or mixtures thereof. However, the shape of the silver powder is not critical to the invention. Additionally, the particle size distribution of the silver particles is not itself critical with respect to the effectiveness of the invention. However, as a practical matter, it is preferred that the particle's size be in the range of 0.1 to 50 microns and preferably 0.1 to 20 microns. Silver particles of the present invention are coated with one or more surfactants, which are generally used to aid in the dispersion of the powder in a suitable polymeric medium. The functionalized particles of the present invention may be completely or partially coated with a surfactant. The surfactant can be, but is not limited to phosphates and phosphate esters, octadecanoic acid, oleic acid, stearic acid, palmitic acid, a salt of an oleate, a salt of stearate, a salt of palmitate and mixtures thereof. The counter-ion can be, but is not limited to, hydrogen, ammonium, sodium, potassium and mixtures thereof.

In one embodiment, a combination of fatty acid surfactants were used to coat the functional silver material (powder).

The functionalized silver particles of the present invention are coated with a surfactant as supplied by the manufacturer. It is required that the silver undergo a heating process prior to incorporation into the composition (heat-treatment). The surfactant coated particles must be heated at a temperature in the range of 100-400° C. for a period of time, typically, but not limited to 10 minutes to 12 hours. This may be done with or without the aid of an inert atmosphere.

In addition to the functionalized silver particles, other materials, such as gold, palladium, platinum, copper, carbon and graphite, and other additives such as silver chloride, Indium/Tin Oxide powder may be present in the polymeric composition of the present invention.

II. Organic Polymer Resin

The organic polymer resin is important to the composition of the present invention. One of the most important requirements for an organic polymer is its ability to disperse functional materials (functional silver material), in the composition. The organic polymer resin may be selected from, but is not limited to polyethers, polyesters, polyamides, polyimides, acrylics and methacrylics, epoxies, polyurethanes, silicones, styrenics, urea and melamine formaldehydes, phenoxies, vinyls, vinyl acetates, fluoro and chloro polymers, polybutadiene and derivatives, polyolefins, polyacrylonitrile, cellulosics, and phenolics.

As a practical matter, the concentration of the organic polymer resin in the total composition in wt % is in the range of 2-40 wt. % and preferably in the range of 5-25 wt. %.

The organic polymer resin is usually used in conjunction with one or more solvents. As an aid to processing, a solution of the organic resin in one or more suitable solvents is usually carried out in advance of the making of the silver paste. The resin/solvent combination is usually referred to as a medium.

III. Solvent

The solvent component of the organic medium, which may be a mixture of solvents, is chosen so as to obtain complete solution therein of the polymer and other organic components. The solvent of the present invention is required in an amount necessary to obtain complete solution of the polymer and other organic components. The solvent should be inert (non-reactive) towards the other constituents of the composition. Such solvents include ketones (such as cyclohexanone, isophorone), hydrocarbons (such as Aromatic 100, 200), ethers, aliphatic alcohols, esters of such alcohols, for example, acetates and propionates (such as butyl acetate, Dowanol PMA acetate); terpenes such as pine oil and alpha- or beta-terpineol, or mixtures thereof; ethylene glycol and esters thereof, such as ethylene glycol monobutyl ether, dipropylene glycol methyl ether, and butyl cellosolve acetate; carbitol esters, such as butyl carbitol, butyl carbitol acetate and carbitol acetate and other appropriate solvents such as Texanol® (2,2,4-trimethyl-1,3-pentanediol monoisobutyrate). Other suitable solvent(s) have lower boiling points such solvents include ethylacetate, methanol, isoproanol, acetone, xylene, ethanol, methylethyl ketone and toluene.

As well as providing solubility of the organic resin, and any other organic species present in the composition, solvents are used to reduce the solids content of the paste to a level where the paste may be applied, for example by dipping, spraying, painting or printing.

IV. Optional Crosslinking Agent

The choice of a crosslinking agent (crosslinker) in the composition is dependent upon the functionality of the organic polymer resins being used in the composition. In some instances, there may be no suitable functionality present in the structure of the organic polymer resin to facilitate crosslinking reactions. In other instances, the overall performance of the organic resin may be sufficient for the end application, and crosslinking would therefore not be necessary.

V. Optional Catalyst

A catalyst is a substance that initiates a chemical reaction under different conditions than would otherwise be possible. They allow for quicker thermal cross-linking and/or thermal cross-linking at lower temperatures. The catalyst is specifically chosen to complement the specific resin/crosslinking agent chemistry.

VI. Other Optional Components

Additional components may be added to the composition(s) of the present invention to impart desired properties. For example, rheology modifiers, adhesion promoters or flow additives may be added.

Applications

Typically, the functional components, detailed above, are mixed with the organic polymer resin (and other optional components) and solvent by mechanical mixing to form a pastelike composition, called “pastes”, having suitable consistency and rheology for printing. The organic medium must be one in which the solids are dispersible with an adequate degree of stability. The rheological properties of the medium must be such that they lend good application properties to the composition. Such properties include: dispersion of solids with an adequate degree of stability, good application of composition, appropriate viscosity, and thixotropy.

This composition may be used in various electronic applications, including conductors and resistors. In particular, the composition of the present invention is used to form the conductive polymeric silver layer (functional polymeric silver layer) of a capacitor. Typically, the capacitor is a tantalum capacitor. However, the composition(s) and method of the present invention may be utilized in niobium and niobium oxide capacitors as well.

Various methods can be utilized to apply the conductive polymeric silver layer onto the conductive carbon/graphite layer. For example, conventional techniques such as sputtering, screen-printing, dipping, electrophoretic coating, electron beam deposition, spraying, and vacuum deposition, can be used to form the conductive polymeric silver layer.

In tests of Ta capacitors comparing capacitors according to the present invention to capacitors of the prior art, the capacitor of the present invention showed a 50% reduction in ESR as measured in m ohms versus the prior art.

1. A conductive polymeric composition comprising: (a) functionalized silver particles and (b) organic polymer resin dispersed in (c) solvent.

2. A method to functionalize silver particles by at least partially coating silver particles with surfactant and heat-treating the particles at a temperature in the range of 100-400° C.
